(19) United States
(12) Patent Application Publication
(10) Pub. No.: US 2026/0336157 A1
(43) Pub. Date: Oct. 29, 2026

(54) METHOD FOR PREPARING A BARREL FORMED BY A TUBULAR ASSEMBLY OF STAVES, COMBINING BENDING, TOASTING AND SMOKING

(71) Applicant: New Alternate Oak, Verrieres (FR)

(72) Inventor: Louis-Auguste Beaudoin, Segonzac (FR)

(21) Appl. No.: 19/106,424

(22) PCT Filed: Aug. 17, 2023
(86) PCT No.: PCT/EP2023/072673

§ 371 Date: Feb. 25, 2025

(30) Foreign Application Priority Data
Aug. 30, 2022 (FR) FR2208680

(51) Int. Cl. B27M 1/06; B27H 5/00; C12G 3/07; C12H 1/22

(52) U.S. Cl. CPC B27M 1/06; C12G 3/07; C12H 1/22; B27H 5/00

(57) ABSTRACT

A method for preparing a barrel formed by a tubular assembly of staves, intended for the gaging of wines, spirits and beers, includes a step of toasting the inside of the barrel by combustion of a combustible material, and a subsequent step of smoking by combustion of plant compounds.

### CROSS-REFERENCE TO RELATED APPLICATIONS

This application is a national phase entry under 35 U.S.C. § 371 of International Patent Application PCT/EP 2023/072673, filed Aug. 17, 2023, designating the United States of America and published as International Patent Publication WO 2024/046774 A1 on Mar. 7, 2024, which claims the benefit under Article 8 of the Patent Cooperation Treaty of French Patent Application Serial No. FR 2208680, filed Aug. 30, 2022.

### TECHNICAL FIELD

The present disclosure relates to the field of cooperage and the aging of wines and spirits in wooden barrels.

### BACKGROUND

Aging in oak barrels is used in oenology in order to enhance the wines. Aromatic molecules (tertiary aromas) and structuring molecules add complexity to the sensory profile of the wine and micro-oxygenation stabilizes this rich mixture of molecules. It has three main effects on wine:
a slow oxidation effect: As wood is a fibrous material, the wine will be able to oxygenate throughout its aging process (which can last several years) and thus stabilize over time. This is why barrel-aged wines often have greater aging potential and finer tannins.
a supply of non-volatile compounds: Wood is a living material. In contact with the wine, it transmits specific aromas, such as vanilla, toast and roasted notes. The newer the barrel, the greater the transmission of aromas.
a supply of volatile compounds.

These will modify the aromatic perception of the wine, with the appearance of these “woody” aromas. They are an integral part of wines aged in oak barrels.

They play a fundamental role in the quality of the aging work. The type of barrel, the origin of the stave wood, the style of the cooper, the duration of aging, the age of the barrel, the type of wine, etc., are all parameters that influence the quality of aging and the aromatic contribution of the barrel.

The whole technical aspect of aging lies in bringing complexity to the wine while respecting the aromatic identity of the grape variety. The aromatic contribution must be subtle and enhance the identity of the wine. It is all in a day's work for the winemaker and the cooper when they agree on the choice of barrel.

The choice of wood and the preparation technique are the first major challenges. The wood used by the cooperage comes from oak trees aged between 120 and 250 years old. These are pedunculate oaks, sessile oaks or holm oaks. When the wood is split into planks (stave wood), only the heartwood is used in cooperage, since it takes 4 m³ of raw wood to obtain 1 m³ of stave wood. Once dry (drying takes 18 months to three years), the stave wood is shaped into staves. The precision of their assembly is essential to guarantee the watertightness of the barrels. Bending gives the barrel its shape. This operation, which is carried out using a winch, is facilitated by heating the shell with a brazier in Europe or with steam in the USA. This step is essential as the intensity of the heat will have an impact on the wine during its maturation. As the macromolecules (tannins, lignin, cellulose, etc.) break down, they release small soluble molecules, some of which are aromatic.

This operation, known as toasting, consists of heating the inside of the oak barrels intended to age wines, spirits and beer, in order to bring out the aromatic balance and the full complexity of the contributions of such barrel aging (notes of vanilla, red fruit, hazelnut, caramel, coffee, smoke, etc.).

The duration and intensity of heating can vary from light to heavy, over different periods of time. A special brazier (“the toasting furnace”) is used to heat the barrels.

In cooperage, toasting is the method that consists of heating the inside of oak barrels intended to age wines, spirits and beers. This operation gives the wines their aromatic balance and the full complexity of the contributions of such barrel aging.

To transfer the oak barrel aromas to tank-aged wines, spirits and beers (or to extend the use of barrels), there are alternative solutions. From an aromatic point of view, the ideal is to “toast” oak planks to reproduce the organoleptic qualities of the staves.

The oak wood heated by virtue of this method is similar in every way to the first few millimeters of the inside of a barrel. It undergoes the same radiant heating, which is very intense and of short duration (compared to kiln-firing), such that throughout the process, the surface layers of the wood are subjected to a much higher temperature than those deeper down.

This thermal gradient in the mass of the wood is fundamental to the complexity of the final product, since chemical reactions are geared toward the formation of different molecules at each given temperature and depend on oxygen enrichment and local humidity.

In a barrel, the drink penetrates the staves on average 4 to 6 mm. In this way, the wine, spirits and beer extract the aromatic molecules typical of the wood. Based on this principle and in order to obtain an aromatic profile as close as possible to that of the barrel, the lumber is planed to 12 mm for optimum penetration on both faces.

Additionally, as in traditional cooperage, the sudden cooling of the wood at the end of heating, allows the rapid recondensation of volatile substances with a low boiling point such as furfural, O-cresol, guaiacol and derivatives thereof.

All the heating conditions therefore contribute to obtaining toasted wood comprising a much higher level of aromatic compounds than toasted wood from a kiln or roaster, both in terms of the diversity of molecules formed and the quantities of each. In contact with a beverage, this characteristic makes the thus treated wood resemble the staves of a barrel.

In the prior art, U.S. Patent Application Publication No. US2004175161 provides an apparatus and a method for the controlled heating and toasting of oak wood in the form of flat staves. The staves are assembled in a panel and heated by far infrared heaters passed in a controlled manner through the panel.

Also known is Canadian Patent No. CA3110881, which describes a method for conditioning wooden barrels, in particular, a method for rapid conditioning of wooden barrels. The method according to the present disclosure may comprise one or more steps of: subjecting a wooden barrel to heat in order to raise the temperature of the wood; placing the heated inner surface of the wooden barrel in contact with a fluid additive; then optionally: subjecting the inside of the wooden barrel to a pressurized environment; and/or subjecting the wooden barrel to further heating; repeating one or more steps; and allowing the wooden barrel to cool, or cooling the wooden barrel to provide a conditioned wooden barrel.

Also known is U.S. Patent Application Publication No. US2009136885, which describes a wine barrel toasting apparatus comprising a platform having an opening therein, the opening being adapted to receive a heat source therethrough, the platform being rotatably arranged about the heat source; and a motor operatively connected to the platform for rotating the platform about the heat source at a substantially constant speed.

Also known is U.S. Patent Application Publication No. US2012164300, which describes a method and a system for aging wines and spirits using finely pulverized wood less than 1 mm in size and in sufficient quantity to achieve aging equivalent to one tenth to one hundredth of the time required for traditional barrel aging and for instant aging.

Prior art solutions are not entirely satisfactory as they offer limited scope for influencing the aromatic nuances of barrels and the wines and spirits aged in these barrels.

### BRIEF SUMMARY

In order to address these drawbacks, the present disclosure relates, in its most general sense, to a method for preparing a barrel.

The barrel is formed of a tubular assembly of staves, intended for the aging of wines, spirits and beers. The method comprises a step of toasting the inside of the barrel by combustion of a combustible material, wherein it comprises a subsequent step of smoking by combustion of plant compounds.

Advantageously, the toasting step is carried out by combustion of a mixture of a combustible material comprising wood chips or sawdust, and an aromatic plant.

According to one variant, the combustible material comprises wood chips or sawdust selected from beech, birch or cedar.

Preferably, the toasting step is carried out with a gradual rise in temperature of the barrel, for at least 20-30 minutes, to reach a temperature inside the barrel greater than or equal to 155 °C.

Advantageously, the toasting step is carried out with an increase in temperature inside the barrel of less than 7 °C per minute.

According to a particular embodiment, the smoking step is initiated when the temperature resulting from the toasting step is between 155 °C and 160 °C inside the barrel.

According to one variant, the smoking step is carried out with a first smoking period of 10 to 20 minutes, then, after refilling with plant compounds, with a second period of smoking the barrel for a further 15 to 30 minutes.

Advantageously, the smoking step involves the combustion of plant compounds in a brazier placed inside the barrel, the barrel being closed by a lid.

The present disclosure also relates to a device for preparing an oak barrel in accordance with the above-mentioned method wherein the device comprises a brazier and a lid for closing a barrel.

### BRIEF DESCRIPTION OF THE DRAWINGS

The present disclosure will be better understood on reading the following description, which concerns a non-limiting exemplary embodiment that is shown by the appended drawings, in which:

FIG. 1 depicts a cross-sectional view of the system for implementing the present disclosure according to a first variant; and

FIG. 2 depicts a cross-sectional view of the system for implementing the present disclosure according to a second variant.

### DETAILED DESCRIPTION

The aim of the present disclosure is to allow the creation of new aromatic profiles in the cooperage sector and in the wood-based oenological products industry. The aim is to meet a strong demand from the wine, beer and spirits industries, which are constantly seeking new products with new aromatic profiles in order to give their alcohols a signature, to distinguish them from their competitors.

The present disclosure is based on the addition of a smoking step, alone or combined with the heating techniques, in particular, bending and/or toasting, in the cooperage process. This solution makes it possible to offer a new, very rich and complex aromatic palette, with a multitude of profiles, using a wide variety of raw materials.

The present disclosure is suitable for barrels made from various wood species and not just oak, and can be applied to new barrels or barrels already used, of any type of wood suitable for cooperage, in particular, all types of oak (Quercus robur, Quercus petraea, Quercus alba, etc.), but also chestnut, acacia, wild cherry, ash (non-exhaustive list).

Embodiments of the present disclosure include methods that include introducing into a barrel a brazier-type heating tool into which the following are successively introduced:
a. during a first step of toasting a combustible material comprising oak wood shavings, whether or not combined with the selected plant compounds; and
b. then, during a second smoking step, plant compounds alone.

The plant compounds can be more or less aromatic such as leaves, branches, trunks; but also fresh fruit (whole or parts), dried fruit (whole or parts), topsoil (peat, potting soil-a non-exhaustive list), straw, hay, etc., are used.

### Application of the Method to a Barrel Being Manufactured

On a new barrel, several variants are possible.

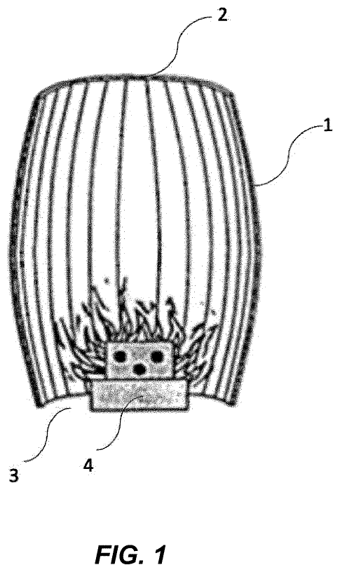

FIG. 1 exemplifies a first variant, with a barrel being manufactured where the staves are assembled to form a cylindrical volume (1) open at both ends (2, 3), with the bottoms not yet in place. The brazier (4) is placed on the ground, followed by the barrel (1), which is open at both front ends.

This first variant involves a two-step toasting method with a combustible material optionally mixed with plant compounds, followed by smoking with the plant compounds when the barrel is being manufactured and does not yet have the bottoms thereof. In this case, a conventional brazier is used, placed on the ground before the barrel is placed around the brazier.

According to the second variant, the operation can also be carried out on new finished barrels. In this case, the brazier to be used will be the same as that for barrels already in use, with only one of the two bottoms of the barrel needing to be removed.

### Application of the Method to a Barrel Already in Use

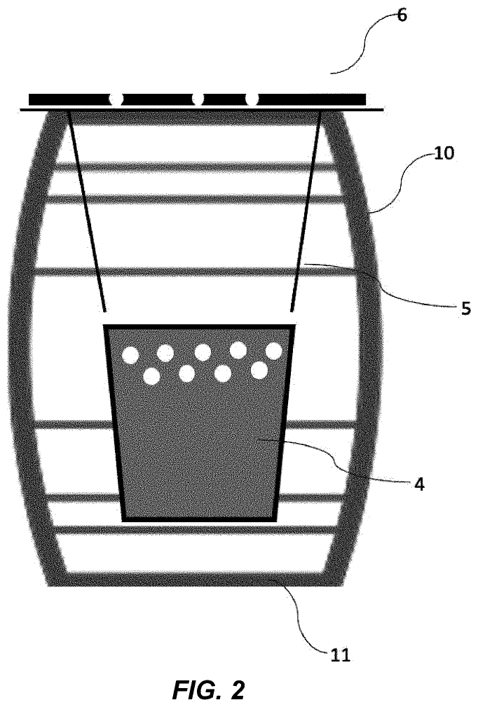

In the case of a barrel that has already been used for aging a wine or a spirit, only one of the two bottoms (11) of the barrel (10) is removed, and a suitable brazier (4) is inserted into the barrel, hooked onto a chain, or positioned at the desired height by arms (5) based on the size of the barrel, as seen in FIG. 2. The brazier is lifted and moved using a hoist. The brazier can be lined with a cover (6), which concentrates the smoke during the smoking step. This cover can be perforated to allow excess smoke to escape.

### First Step: Heating the Barrel—Toasting

Regardless of the type of barrel (used or being manufactured or new), this toasting is carried out with a gradual rise in temperature of the barrel, lasting a minimum of 20-30 minutes, to finally reach a temperature inside the barrel greater than or equal to 155 °C; while respecting a maximum temperature increase inside the barrel of 7 °C per minute.

Of course, if the method is carried out on a new barrel being manufactured, it will first be necessary to carry out the toasting step, corresponding to aromatic heating during a traditional process for manufacturing new barrels, then to wait for the inside of the barrel to come down to room temperature; and finally to carry out a second toasting step to make the first toasting more complex and to carry out this new toasting adapted to the present disclosure.

The toasting step is performed with the oak wood blended with the wood of the plant selected for heating, with 50% oak wood and 50% wood of the other species.

If the temperature struggles to reach 160 °C, oak wood is added.

If the temperature increase up to 160 °C occurs too quickly, water is sprayed inside the barrel in order to lower the temperature inside the barrel.

This toasting step reopens the pores in the wood to allow optimal exchange with the smoke produced by the burning of plant compounds.

### Second Smoking Step

The optimum temperature to start the second smoking step is 160 °C

Smoking is achieved by adding half the quantity of plant compounds (wood, leaves, fruit, etc.) to the brazier. This smoking step has the effect of superficially modifying the staves through a combination of heating the oak during the first toasting step and smoking the surface layer of the staves by the volatile compounds of the smoke produced by the combustion of the smoking material.

After loading the brazier with the plant compounds, a lid is placed on top of the barrel in order to keep the smoke within the interior volume of the barrel.

The lid may or may not be perforated, to adjust the flow rate of smoke escaping from the barrel.

After a first smoking period, for example, after 10 to 20 minutes and preferably 15 minutes of smoking, the second part of the plant compounds is added to the brazier (the fire having been smothered during the first addition, only the embers are still active).

The barrel is then smoked a second time for a further 15 to 30 minutes, preferably 25 minutes.

Next, the brazier is removed from the barrel, and the bottom of the barrel is repositioned to close it and block the bunghole to preserve as much of the aroma as possible and to ensure a slower drop in temperature.

The barrel is then filled immediately afterwards; as soon as possible-ideally within the hour.

It is important that the barrel is still warm during filling, at a temperature greater than 40 °C, in order to promote the exchanges between the wood and the alcohol and thus amplify the extractions.

The barrels are filled with an alcohol content of between 55% and 65% abv.

The invention allows new aromatic profiles to be created for new and used barrels, based on the type of barrel, new or used, which is an important choice for the toasting and subsequent smoking processes, in order to obtain different aromatic profiles.

In particular, the method is suitable for toasting and smoking a barrel from the “Giraud-Galiana” range of new barrels that correspond to the ideal barrels.

The type of wood used (oak, acacia, chestnut—a non-exhaustive list) to make a new barrel, helps to adapt the final aromatic profile of the barrel in relation to the bending, toasting and smoking processes. This makes the chosen profile more complex and diversified.

For second-hand barrels, the type of emptying tends to have a positive and/or negative impact on the final aromatic profile, in direct relation to the toasting and smoking methods used.

The embers inside the brazier allow the essences to be extracted by combustion, which, in their gaseous phase, come into contact with the wood and penetrate inside the pores of the wood.

Various raw materials, which are more or less solid and more or less aromatic, can be used as a second combustible material, in association with the main combustible material: oak pieces, during the bending, and/or toasting, and/or smoking processes, or on the contrary without using oak as the main combustible material.

The lid, which may or may not be perforated, is preferably made of stainless steel or cast iron, but can also be made of wood and allows different final aromatic results to be obtained: more or less smoky, more or less fruity, more or less subtle and elegant.

1. A method for preparing a barrel formed by a tubular assembly of staves, intended for the aging of wines, spirits and beers, the method comprising a step of toasting the inside of the barrel by combustion of a combustible material, and a subsequent step of smoking by combustion of plant compounds.

2. The method of claim 1, wherein the toasting is carried out by combustion of a mixture of a combustible material consisting of wood chips or sawdust, and an aromatic plant.

3. The method of claim 2, wherein the wood chips or sawdust consists of wood chips or sawdust selected from beech, birch or cedar.

4. The method of claim 1, wherein the toasting is carried out with a gradual rise in temperature of the barrel, for at least 20-30 minutes, to reach a temperature inside the barrel greater than or equal to 155 °C.

5. The method of claim 4, wherein the toasting is carried out with an increase in temperature inside the barrel of less than 7 °C per minute.

6. The method of claim 1, wherein the smoking is initiated when the temperature resulting from the toasting step is between 155 °C and 160 °C inside s the barrel.

7. The method of claim 1, wherein the smoking step is carried out with a first smoking period of 10 to 20 minutes and then, after refilling with plant compounds, with a second period of smoking the barrel for a further 15 to 30 minutes.

8. The method of claim 1, wherein the smoking involves the combustion of plant compounds in a brazier placed inside the barrel, the barrel being closed by a lid.

9. A device for use in preparing an oak barrel by a method according the claim 1, wherein the device consists of a brazier and a lid for closing a barrel.
